(19) United States
(12) Patent Application Publication
(10) Pub. No.: US 2003/0230703 A1
(43) Pub. Date: Dec. 18, 2003

(54) Optical object discriminating apparatus, processing system and transport processing system

(75) Inventors: Hisakazu Sugiyama, Kitakatsuragi-gun (JP); Akifumi Yamaguchi, Kashiba-shi (JP)

Correspondence Address: MORRISON & FOERSTER LLP, 1650 TYSONS BOULEVARD, SUITE 300, MCLEAN, VA, 22102, US

(73) Assignee: SHARP KABUSHIKI KAISHA, Osaka (JP)

(21) Appl. No.: 10/446,125

(22) Filed: May 28, 2003

(30) Foreign Application Priority Data
May 29, 2002 (JP) 2002-155361
Feb. 13, 2003 (JP) 2003-035028

(51) Int. Cl. G01J 1/00; H01J 40/00

(52) U.S. Cl. 250/200

(57) ABSTRACT

According to the optical object discriminating apparatus, light emitted from a light-emitting device is collimated by a collimator lens, concentrated by an object lens and applied to an object to be detected moving in a prescribed direction so as to form a light spot having a prescribed diameter. Light reflected from at least a partial region in the light spot is concentrated via a light-receiving lens and made incident on a light-receiving device. An operation processing circuit discriminates a type of the object to be detected on the bases of an amplitude and an output level of a waveform outputted from the light-receiving device.

### BACKGROUND OF THE INVENTION

The present invention relates to an optical object discriminating apparatus, processing system and transport processing system, and in particular, to an optical object discriminating apparatus for discrimination among the types of papers such as printing papers, resin films and sheets and processing systems and transport processing systems of copying machines, printers and the like employing the optical object discriminating apparatus.

Copying machines and printers, which carry out processing while transporting a recording medium, have been developed to have higher performance, higher processing speed and higher resolution, and the recording medium to be used include various types of regular paper, glossy paper, and OHP (overhead projector) sheet and the like. In order to form high-quality images in correspondence with differences in the infiltration rate of ink and drying time depending on the various types of recording media with a printer of an image recording apparatus or in, among others, an ink jet recording system printer as described above, it is required to execute recording control in correspondence with each of the recording media.

Conventional methods for detecting the recording media of papers such as printing papers, resin films, sheets and the like include:

(1) a mechanical detection method for detecting the type of the recording medium by a change in the amount of displacement of a contactor or the like when the recording medium is inserted in a transport section;

(2) a thermal detection method for carrying out recording medium type detection by a change in heat of a recording medium or a change in heat of a heating body itself while applying a heating body to the recording medium; and

(3) an optical detection method for carrying out sheet type detection with a light-emitting device and a light-receiving device by a change in the quantity of reflection light from a sheet when light of a light-emitting device is applied to the recording medium.

As an optical object discriminating apparatus according to the aforementioned optical detection method, as shown in FIG. 15, there is one for discriminating the type of the sheet by a change in the output of a light-receiving device 52 according to the angles of arrangement of a light-emitting device 53a (53b) and the light-receiving device 52 (refer to, for example, Japanese Patent Laid-Open Publication No. HEI 10-198174).

Moreover, as an optical object discriminating apparatus of another optical detection method, as shown in FIG. 16, there is one for carrying out sheet discrimination by executing two-dimensional image processing by means of an image sensor of CCD, CMOS or the like, which is a two-dimensional optical detection array, in a light-receiving section (refer to, for example, Japanese Patent Laid-Open Publication No. 2000-301805). In FIG. 16, there are shown a sensor element 61, an image-forming optical device 62, a small aperture 63, an illumination light source 64, an illumination optical device 65, an amplitude beam splitter 66, an illumination optical device 67, an illumination light source 68, a recording medium 69, an illumination optical device 70 and an illumination light source 71.

As an optical object discriminating apparatus of yet another optical detection method, there is one that detects the type of a recording medium by infiltrating a detection liquid containing a prescribed coloring matter or a fluorescent substance into the recording medium, applying light having a wavelength region to be absorbed by the coloring matter or the fluorescent substance to the infiltrated portion, and measuring the reflected reflection light intensity, or applying an infrared ray and measuring the infrared ray absorption spectrum of the reflected ray.

According to the aforementioned mechanical detection method and the thermal detection method, it is required to establish contact with the recording medium, and there are possibilities of hindering the movement of the recording medium being transported and concurrently causing a change in the shape of the recording medium. Moreover, there is a concern about the possible occurrence of erroneous detection ascribed to the deterioration of the contact portion due to wearing out.

Moreover, the aforementioned optical detection method needs a plurality of light-emitting devices or light-receiving devices of which the angles of arrangement are different in order to increase the detection accuracy, and therefore, the number of parts increases, leading to a complicated construction and coast increase. Moreover, according to the aforementioned optical detection method, one that employs an image sensor in the light-receiving section has complicated processing, and it is required to increase the elements for determination as the discrimination accuracy is increased. This leads to a more complicated construction and also expensive element cost, and it is required to pay attention to the adjustment of the angles of arrangement of the light-emitting devices and the light-receiving devices. In addition, if the apparatus is constructed of a plurality of light-emitting devices and one light-receiving device, then complicated signal processing results since the light-emitting timing of each of the light-emitting devices is required to be shifted.

Moreover, according to the method of infiltrating the detection liquid and measuring the reflection light from the portion, there is the possibility of giving the recording medium a change in the coloring matter and contamination. In addition, there is needed a means for infiltrating the detection liquid, resulting in increasing the size of the apparatus, and the construction of the light-receiving section and the signal processing become complicated in order to measure the infrared ray absorption spectrum.

### SUMMARY OF THE INVENTION

Accordingly, the object of the present invention is to provide a low-cost optical object discriminating apparatus, processing system and transport processing system capable of accurately discriminating the type of an object such as a recording medium with a simple construction and signal processing without establishing contact with the object.

In order to solve the aforementioned problems, the optical object discriminating apparatus of the present invention forms a light spot having a prescribed spot diameter on an object to be detected by concentrating light emitted from a light-emitting device (preferably, a semiconductor laser device) by means of an optical system and applying the light to the object to be detected moving in a prescribed direction. This light spot has a size of about 10 μm to 100 μm (preferably, 10 μm to 50 μm), and light reflected from at least a partial region in this light spot is concentrated via the optical system and thereafter made incident on the light-receiving device. The optical system should preferably be constructed of a collimator lens and an object lens (or one combinational lens) and a light-receiving lens.

With the above arrangement, when the object to be detected moves, the signal detected by the light-receiving device comes to have a difference in amplitude due to the material and the surface state (level of unevenness) of the object to be detected, and a difference appears also in output level (mean value or the like of an output). Therefore, by measuring this amplitude and the output level and executing processing on an electric circuit, the type of the object to be detected can be detected. Therefore, with the simple construction and the signal processing, the type of the object can be accurately discriminated without establishing contact with the object of a recording medium or the like, and cost reduction can be achieved.

In the aforementioned construction, if a pinhole is arranged in front of the light-receiving device, then the light-receiving device receives the reflection light from the limited region of the object to be detected even though the light spot is not narrowed down to about several tens of micrometers, and the level of unevenness of the object to be detected can be accurately detected.

By arranging the optical axis of the light applied to the object to be detected roughly perpendicular to the plane of the object to be detected, fluctuations in the spot size can be reduced, and the detection accuracy of surface unevenness of the object can be improved.

Moreover, on the occasion of concentrating the reflection light, if this optical axis is arranged coaxially with the optical axis on the light-applying side, then size reduction can be achieved. Furthermore, if the optical axes on both the light-applying side and the light-reflecting side are roughly perpendicular, then detection by the light-receiving device becomes detection of a regular reflection light, improving the S/N ratio (signal-to-noise ratio) and improving the discrimination accuracy of the type of the object to be detected. For example, in order to arrange the optical axis on the light-applying side and the optical axis on the light-reflecting side of the object to be detected roughly perpendicular to the plane of the object to be detected, either of the optical axes is rotated to a prescribed angle by means of a beam splitter, a diffraction grating or the like.

In addition, if the pinhole size is adjusted to 10 μm to 50 μm in diameter, then the reflection light from the limited region can be received even though the size of the light spot varies to some extent, making it possible to prevent the averaging of the level of unevenness of the surface of the object to be detected and increasing the detection accuracy. If the diameter of the pinhole is greater than 50 μm, then the surface state is to be read by the reflection light from a wide area of the object to be detected. Therefore, the information of the surface roughness is averaged to reduce the position-dependent difference, and the true surface state cannot be read. If the diameter of the pinhole is smaller than 10 μm, though the surface state might be accurately read, the quantity of light becomes insufficient because of excessively small diameter, failing in obtaining an appropriate signal.

There is needed a casing for retaining these optical components in prescribed positional relations, and by providing this casing with a guide for guiding the object to be detected, the object to be detected is made to pass at a prescribed distance from the optical system.

Moreover, by employing an optical object discriminating apparatus in a path, through which the object to be detected pass, of a transport processing system for carrying out prescribed processing while moving the object to be detected, the type of the object to be detected can be detected when the object to be detected moves, and by sending this information to a processing unit, prescribed processing can be carried out according to the detected type of the object.

Furthermore, two sets of light-emitting devices, light-receiving devices and optical systems are arranged at prescribed intervals on a straight line parallel to the direction in which the object to be detected moves. At this time, output waveforms of the two light-receiving devices in accordance with the movement of the object to be detected are in such forms that the other waveform is delayed in terms of time from one waveform, and by processing this delay on an electric circuit, the travel speed of the object to be detected can be measured. That is, the travel speed of the object to be detected is obtained on the basis of the distance between the two light spots on the object to be detected and the time difference that represents the delay.

In addition, it is possible to provide a transport processing system, which is able to maintain constant the speed of the object to be detected by feeding the travel speed of the object to be detected measured by the optical object discriminating apparatus back to the transport system or to process the object according to its detected type by feeding the travel speed back to the timing of the processing in a prescribed position when the object to be detected is processed during transportation.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic structural view of an optical object discriminating apparatus according to a first embodiment of this invention;

FIG. 2 is a view showing one example of the light-applying side optical system when a combinational lens is employed;

FIGS. 3A and 3B are schematic views showing a state of fluctuation in light spot size when an incident angle to the object to be detected is perpendicular and when the angle is nonperpendicular, respectively;

FIGS. 4A through 4C are views showing examples of the output waveforms of the light-receiving device of the optical object discriminating apparatus when the object to be detected is a regular paper, a photographic glossy paper and an OHP sheet, respectively;

FIG. 5 is a view for explaining the relation between a light spot, a pinhole and a concentrated light spot;

FIG. 6 is a sectional view showing a state in which a pinhole is arranged in front of the light-receiving device;

FIG. 7 is a schematic structural view of an optical object discriminating apparatus according to a second embodiment of this invention;

FIG. 8 is a schematic structural view of an optical object discriminating apparatus employing a combinational lens;

FIGS. 9A and 9B are schematic views showing a state in which light is reflected by unevenness on a sheet surface when an incident angle to the object to be detected is perpendicular and when the angle is nonperpendicular, respectively;

FIGS. 10A through 10D are views showing examples of the output waveforms of the light-receiving device of the optical object discriminating apparatus when the object to be detected is a regular paper, a glossy paper, a photographic glossy paper and an OHP sheet, respectively;

FIG. 11A is a sectional view of an optical object discriminating apparatus provided with a casing having a guide for guiding the object to be detected; FIG. 11B is a sectional view viewed from a line XI-XI in FIG. 11A;

FIGS. 12A and 12B are views showing examples of the output waveforms of a light-receiving device in an optical object discriminating apparatus provided with two sets of light-emitting devices, light-receiving devices and optical systems;

FIG. 13 is a schematic structural view of a transport processing system capable of carrying out the processing of an object to be detected in prescribed positions according to the type of sheet by employing an optical object discriminating apparatus according to a third embodiment of this invention;

FIG. 14 is a block diagram of the above transport processing system;

FIG. 15 is a schematic view for explaining the principle of detection of a conventional optical object discriminating apparatus; and

FIG. 16 is a schematic structural view of a conventional optical object discriminating apparatus.

### DETAILED DESCRIPTION OF THE PREFERRED EMBODIMENTS

The optical object discriminating apparatus, processing system and transport processing system of this invention will be described in detail below on the basis of the embodiments thereof shown in the drawings.

(First Embodiment)

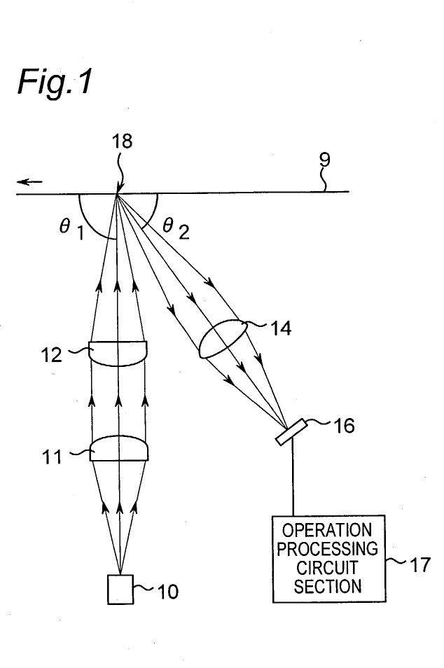

FIG. 1 is a schematic structural view of the optical object discriminating apparatus of the first embodiment of this invention. There are shown an object 9 to be detected, a light-emitting device (preferably, a semiconductor laser device) 10, a collimator lens 11, an object lens 12, a light-receiving lens 14, a light-receiving device 16 and an operation processing circuit 17 that serves as one example of a discrimination section for discriminating the type of the object 9 to be detected upon receiving a signal from the light-receiving device 16. An optical system is constructed of the collimator lens 11, the object lens 12 and the light-receiving lens 14.

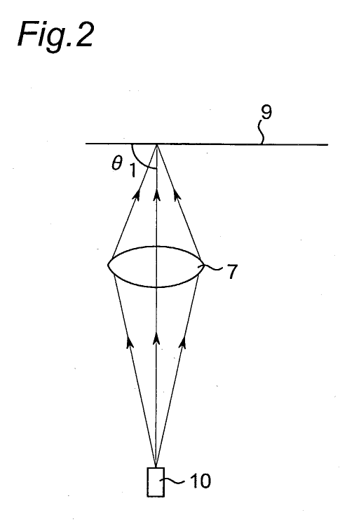

As shown in FIG. 1, light emitted from the light-emitting device 10 is collimated by the collimator lens 11, and thereafter, the light concentrated by the object lens 12 is applied to the object 9 to be detected, forming a light spot 18 on the object 9 to be detected moving in a prescribed direction. At this time, a light spot can be formed by one combinational lens 7 as shown in FIG. 2. The light reflected from this light spot 18 travels in all directions, while the light, which is concentrated by the light-receiving lens 14 and made incident on the light-receiving device 16, is reflected from a limited region (a partial region in the light spot 18) on the object 9 to be detected.

In this case, the region of the light spot 18 on the object 9 to be detected shown in FIG. 1 has a size of about 10 μm to 100 μm in diameter. When the size of the light spot 18 is smaller than 10 μm, the quantity of light incident on the light-receiving device 16 is a little, and a sufficient output cannot be obtained. When the size of the light spot 18 is larger than 100 μm, an output signal has a great absolute quantity but disadvantageously has a degraded signal-to-noise ratio since a signal obtained by averaging the surface state of the object 9 to be detected is to be received.

In the optical object discriminating apparatus of the above-mentioned construction, when the object 9 to be detected moves the signal detected by the light-receiving device 16 comes to have a difference in amplitude due to the material and the surface state (level of unevenness) of the object 9 to be detected. Moreover, a difference also appears in the output level of the signal detected by the light-receiving device 16, and therefore, the type of the object 9 to be detected can be detected by measuring this amplitude and the output level and carrying out processing on an electric circuit.

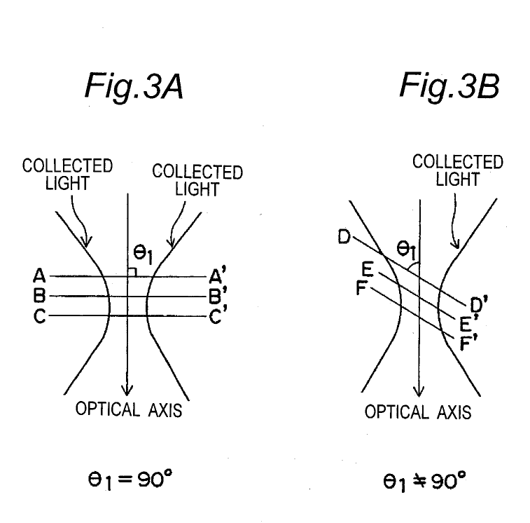

FIGS. 3A and 3B are examples in which an incident angle to the object to be detected on the light-applying side is perpendicular and in which the angle is nonperpendicular. When the angle is nonperpendicular as shown in FIG. 3B, the difference in the light spot size increases depending on the positions of the surface of the object to be detected like D-D′, E-E′ and F-F′ as the angle θ becomes smaller. However, when the angle is perpendicular as shown in FIG. 3A, the detection accuracy is improved since there is scarce difference in the light spot size in the positions of the surface of the object to be detected like A-A′, B-B′ and C-C′.

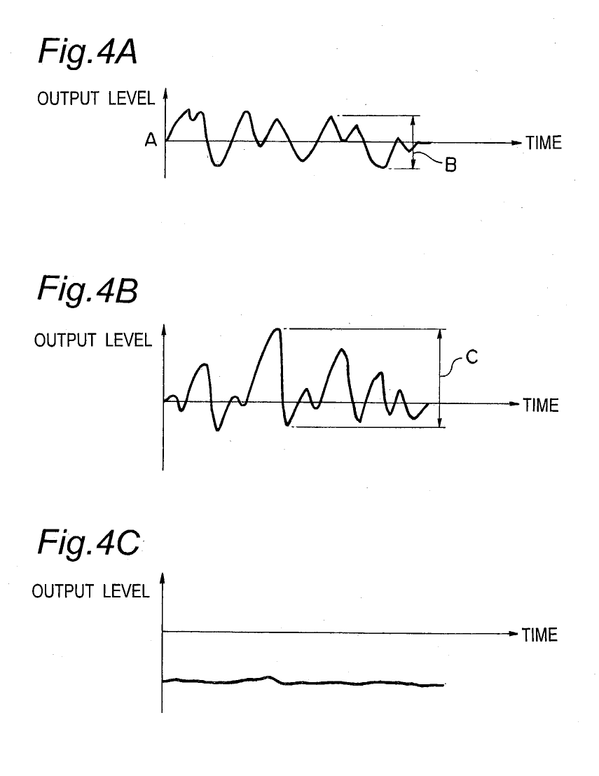

FIGS. 4A through 4C show the output waveforms of the light-receiving device 16 (shown in FIG. 1) by the type of the sheet when θ1=90° and θ2=75° in this first embodiment. FIG. 4A shows a change in an output level A of the light-receiving device 16 and its amplitude B when the object to be detected is a regular paper, FIG. 4B shows a change in the output level of the light-receiving device 16 and its amplitude C when the object to be detected is a photographic glossy paper, and FIG. 4C shows a change in the output level of the light-receiving device 16 when the object to be detected is an OHP sheet.

When the object 9 to be detected (shown in FIG. 1) is moved at a certain constant speed, then the output of the light-receiving device 16 comes to have the output level A and the amplitude B as shown in FIG. 4A in the case of the regular paper. In the case of the photographic glossy paper, as shown in FIG. 4B, the output level is slightly greater than A, and the amplitude C comes to have a magnitude about one-and-a-half times as large as B. In the case of the OHP sheet (level of unevenness: about 2 μm), as shown in FIG. 4C, the reflection light is scarcely made incident on the light-receiving device 16, and no output is obtained. Therefore, assuming that the output level and the amplitude in the case of the regular paper are each one, then the results of the mutual relations are collectively shown in Table 1.

TABLE 1

| | | Photographic | |
|---|---|---|---|
| | Regular Paper | Glossy Paper | OHP Sheet |
| Output Level | 1 | ≈2 | ≈0 |
| Amplitude | 1 | ≈1.5 | ≈0 |

(In Table 1, denotes approximately equal to)

As shown in Table 1, the three sheet types can be discriminated by making determination by executing processing on an electric circuit on the basis of the two factors of the output level and the amplitude.

As described above, according to the optical object discriminating apparatus of the first embodiment, the type of the object of the recording medium or the like can be accurately discriminated with a simple construction and signal processing without establishing contact with the object, and size reduction and cost reduction can be achieved.

Moreover, by employing a semiconductor laser device of which the light-emitting section has a point light source as the light-emitting device 10, light can be efficiently concentrated by the lens, and the quantity of light necessary for signal detection in the light-emitting device can be obtained from the reflection light on the object to be detected.

Moreover, by arranging the optical axis of the light applied to the object 9 to be detected roughly perpendicular to the plane of the object 9 to be detected, fluctuations in the light spot size can be restrained, and the detection accuracy is improved.

Reference is next made to the case where a pinhole 15a is arranged as a means for increasing the detection accuracy just in front of the light-receiving device 16 in this first embodiment.

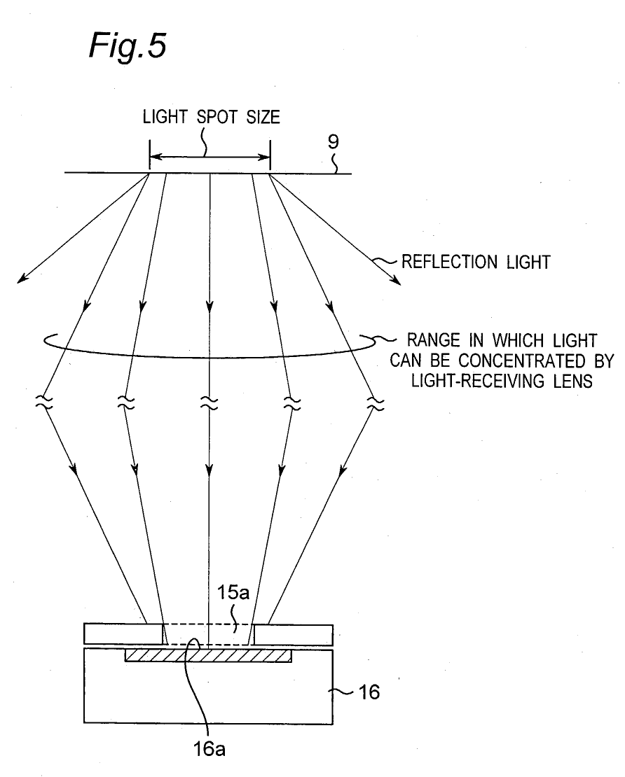

FIG. 5 shows the relation between a light spot, the pinhole 15a and a concentrated light spot. As shown in FIG. 5, light reflected from the light spot travels in all directions, among which the light concentrated by the light-receiving lens 14 is arranged so as to focus on a light-receiving surface 16a of the light-receiving device 16. However, if the light spot size on the object 9 to be detected exceeds 100 μm, then the size of the concentrated light spot on the light-receiving device 16 is also increased, and the optical intensity is averaged, failing in obtaining an output conforming to the level of unevenness of the object 9 to be detected. Accordingly, by arranging the pinhole 15a just in front of the light-receiving device 16, the light incident on the light-receiving device 16 through the pinhole 15a is the light reflected from a further limited region in the light spot 18 on the object 9 to be detected. Consequently, an output conforming to the level of unevenness of the object 9 to be detected can be obtained, and the influence of external disturbance light can also be reduced.

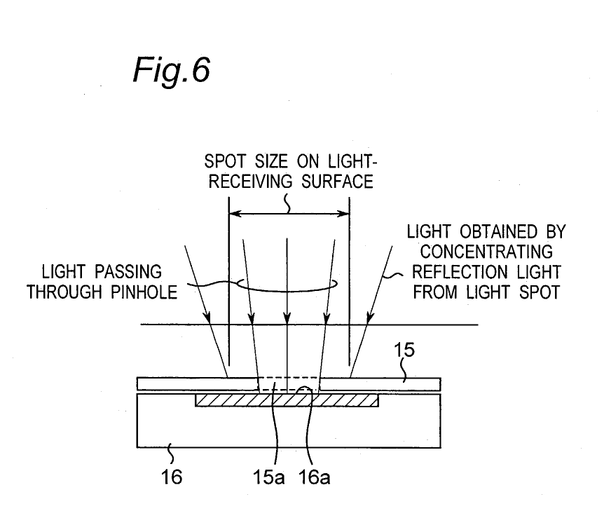

As shown in FIG. 6, when a mask 15 having the pinhole 15 a is arranged in front of the light-receiving device 16, then the light, which passes through the pinhole 15a (preferably, having a size of 10 μm to 50 μm) and is incident on the light-receiving device 16, becomes light reflected from the limited region in the light spot even though the spot size on the light-receiving surface 16a of the light-receiving device 16 exceeds 100 μm, and an output waveform conforming to the level of unevenness of the surface of the object 9 to be detected can be obtained. When the size of the pinhole 15a is set to 10 μm to 50 μm, then the reflection light from the limited region on the surface of the object 9 to be detected can be received even though the size of the light spot varies to some extent, and the surface state can be prevented from being averaged.

(Second Embodiment)

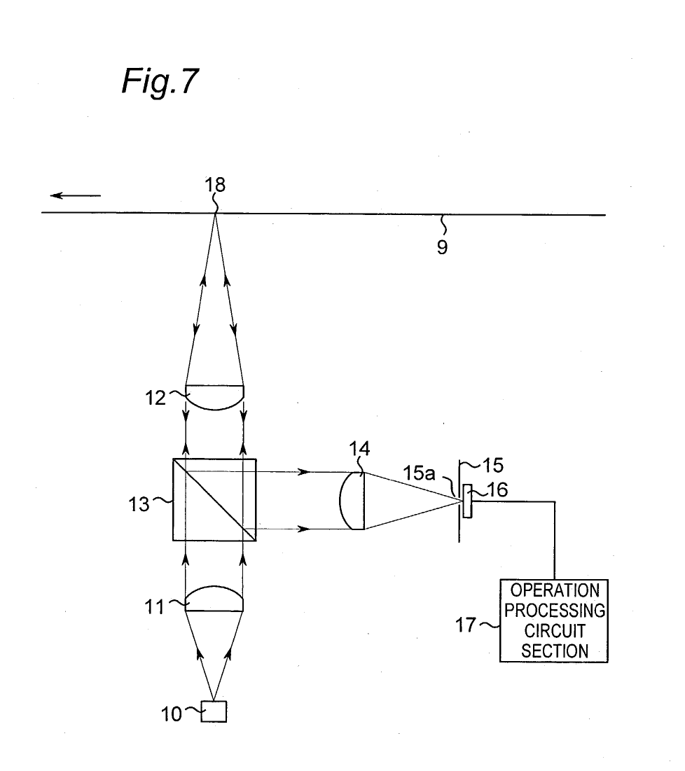

FIG. 7 is a schematic structural view of the optical object discriminating apparatus of the second embodiment of this invention. There are shown an object 9 to be detected, a light-emitting device (preferably, a semiconductor laser device) 10, a collimator lens 11, an object lens 12, a bean splitter 13, a light-receiving lens 14, a mask 15 having a pinhole 15a, a light-receiving device 16 and an operation processing circuit 17 that serves as one example of a discrimination section for discriminating the type of the object 9 to be detected upon receiving a signal from the light-receiving device 16. An optical system is constructed of the collimator lens 11, the object lens 12, the beam splitter and the light-receiving lens 14.

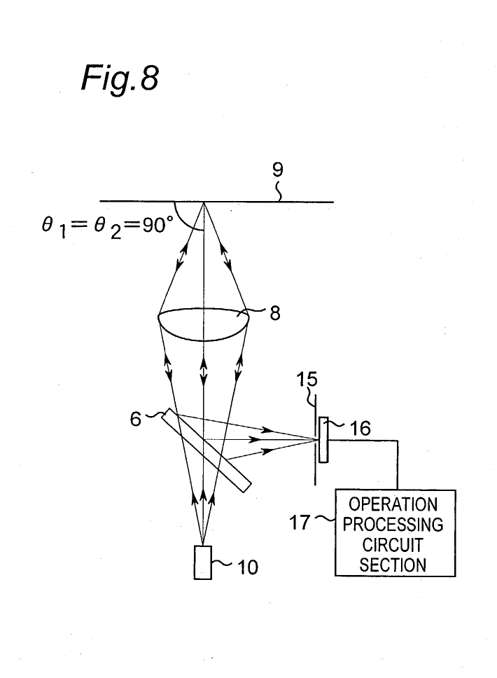

As shown in FIG. 7, the optical object discriminating apparatus of this second embodiment collimates light emitted from the light-emitting device 10 by means of the collimator lens 11, thereafter concentrates the light that has passed through the beam splitter 13 by the object lens 12 and applies the concentrated light so that its optical axis becomes roughly perpendicular to the plane of the object 9 to be detected, forming the light spot 18 on the object 9 to be detected moving in a prescribed direction. The light reflected from this light spot 18 travels in all directions and passes partly through the object lens 12. Subsequently, the optical axis is rotated by a prescribed angle by the beam splitter 13, thereafter the light is concentrated by the light-receiving lens 14 and made incident on the light-receiving device 16 through a pinhole 15. The light incident on the light-receiving device 16 is the light reflected from the limited region (at least a partial region in the light spot) on the object 9 to be detected. When a combinational lens is employed, a construction as shown in FIG. 8 is provided. In FIG. 8, there are shown a combinational lens 8 and a beam splitter 6. An angle θ1 made between the optical axis of the applied light and the object 9 to be detected is set at 90°, and an angle θ2 made between the optical axis of the reflection light concentrated by the combinational lens and the plane of the object 9 to be detected is set at 90°.

As shown in FIG. 5, light reflected from the light spot travels in all directions, among which the light concentrated by the light-receiving lens 14 is arranged so as to focus on the light-receiving surface 16a of the light-receiving device 16. However, if the light spot size on the object 9 to be detected exceeds 100 μm, then the spot size on the light-receiving surface 16a of the light-receiving device 16 is also increased, and the optical intensity is averaged, failing in obtaining an output conforming to the level of unevenness of the object 9 to be detected.

While, when the pinhole 15a is arranged just in front of the light-receiving device 16 as shown in FIG. 6, the light, which passes through the pinhole 15a (preferably, having a size of 10 μm to 50 μm) and is made incident on the light-receiving device 16, is the light reflected from the limited region in the optical spot even though the spot size on the light-receiving surface 16a of the light-receiving device 16 exceeds 100 μm, and an output waveform of both an amplitude and an output level conforming to the level of unevenness of the object 9 to be detected can be obtained.

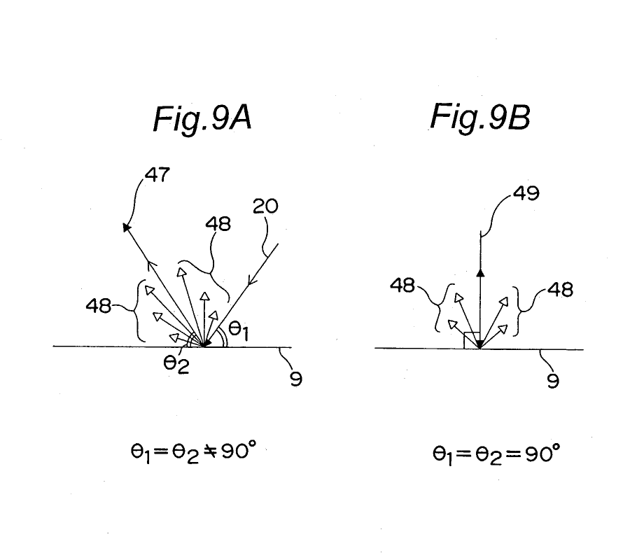

In the optical object discriminating apparatus of this second embodiment, the paths of the incident light and the reflection light are same (perpendicular to the plane of the object 9 to be detected) dissimilarly to the first embodiment, and the apparatus can be reduced in size by adopting a coaxial structure. Furthermore, since the paths of the incident light and the reflection light are roughly perpendicular, the reflection light incident on the light-receiving device comes to have a regular reflection component. When angles made between the object to be detected and the incident light and the reflection light, respectively, are same as shown in FIGS. 9A and 9B, then a regular reflection light component is obtained, and its intensity (except for the specific case where the reflective object is a diffuser plate or an absorber plate) is greater than that of diffused reflection light. Therefore, since the light-receiving output level is great, the S/N ratio is increased to improve the detection accuracy, and discrimination between the regular paper and the glossy paper, which have a little difference with regard to the surface state, can be achieved.

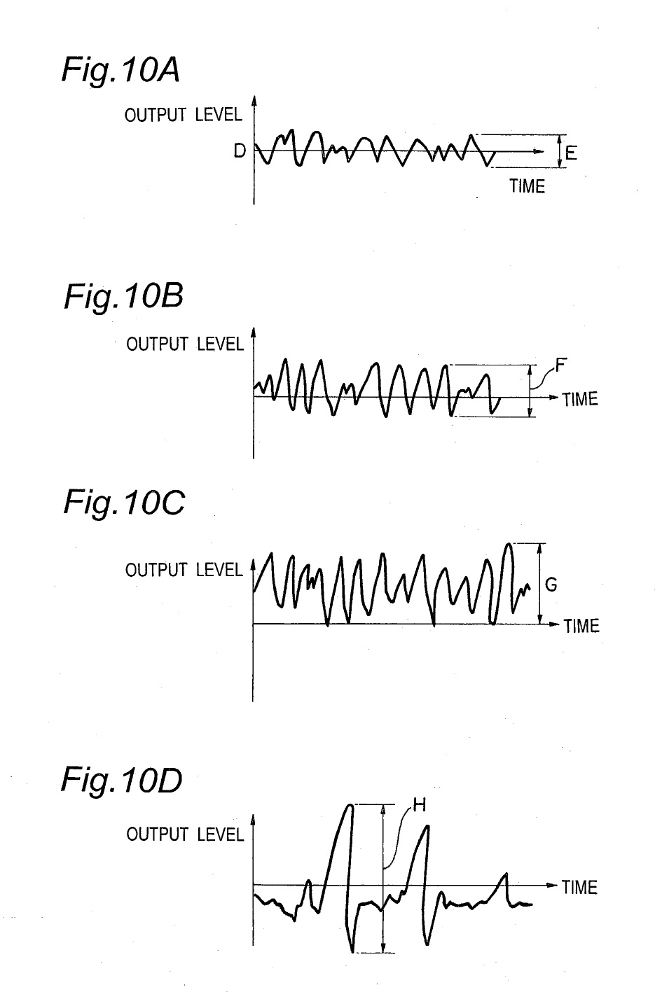

FIGS. 10A through 10D show examples of the output waveforms of the light-receiving device 16 (shown in FIG. 7) of this second embodiment. FIGS. 10A, 10B, 10C and 10D show changes in the output level of a regular paper, a glossy paper, a photographic glossy paper and an OHP sheet, respectively.

As shown in FIGS. 10A through 10D, with respect to the output level D and the amplitude E of the regular paper, the output level of the glossy paper is slightly greater, and the amplitude F of the glossy paper is about one-and-a-half times as large as the amplitude E of the regular paper. Moreover, the photographic glossy paper has an output level about three times as large as the output level D of the regular paper and an amplitude G about two-and-a-half times as large as the amplitude E of the regular paper. Moreover, the OHP sheet has an output level slightly lower than that of the regular paper and an amplitude H two-and-a-half to several times as large as the amplitude E of the regular paper. Therefore, assuming that the output level and the amplitude of the regular paper are each one, then the results of the mutual relations are collectively shown in Table 2.

TABLE 2

| | | | Photographic | |
|---|---|---|---|---|
| | Regular | Glossy | Glossy | |
| | Paper | Paper | Paper | OHP Sheet |
| Output | 1 | 26 1.2 | ≈3 | ≈0.8 |
| Level | | | | |
| Amplitude | 1 | ≦1.5 | ≈2.5 | 2.5≦ |

(In Table 2, denotes approximately equal to)

As shown in Table 2, the four sheet types can be discriminated by making determination by executing processing on an electric circuit on the basis of the two factors of the output level and the amplitude.

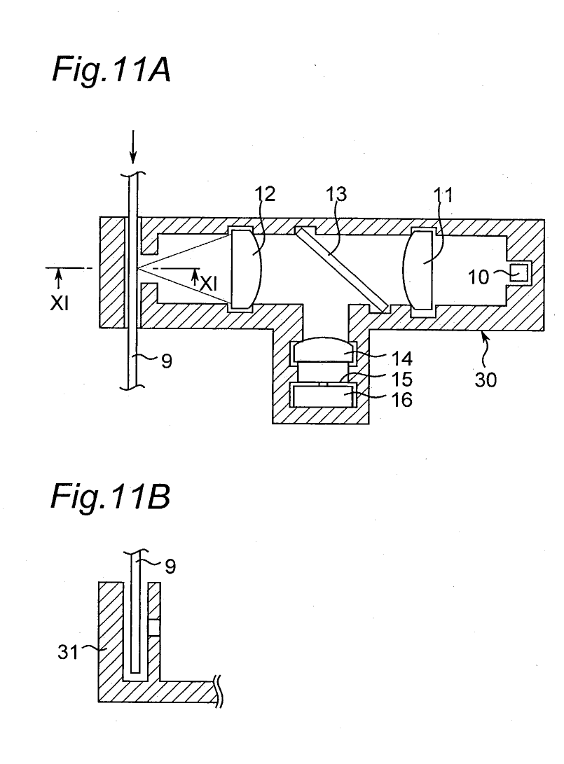

Next, a casing for retaining these optical components and so on in prescribed positional relations is needed. FIG. 11A is a sectional view of an optical object discriminating apparatus provided with a casing 30 having a guide 31 through which the object 9 to be detected passes. As shown in FIG. 11A, the object 9 to be detected passes at a prescribed distance from the object lens 12 by the guide 31 of this casing 30. With this arrangement, fluctuations in the distance between the object 9 to be detected and the object lens 12 can be reduced, and accurate detection can be achieved.

When the optical object discriminating apparatus having the construction as described above is arranged at the leading end of a sheet movement path of a processing system like a printer for executing processing by moving a sheet, then the sheet type can be discriminated simultaneously with the start of movement of the sheet. By sending this information to a processing unit, a processing system such as a copying machine and a printer capable of automatically setting printing according to the sheet type and printing conditions can be achieved.

As described above, according to the optical object discriminating apparatus of the second embodiment, the type of the object of a recording medium or the like can be accurately discriminated with the simple construction and signal processing without establishing contact with the object, and size reduction and cost reduction can be achieved.

Moreover, by employing a semiconductor laser device of which the light-emitting section has an approximate point light source as the light-emitting device 10, light can be efficiently concentrated, and the quantity of light required for the signal detection in the light-receiving device 16 can be obtained from the reflection light from the object to be detected.

Moreover, by arranging the pinhole 15a in front of the light-emitting device 10, only the reflection light from the limited region in the light spot 18 can be made incident on the light-receiving device 16 even though the light spot 18 is not narrowed down to several tens of micrometers, and the influence of the external disturbance light can be concurrently eliminated.

Moreover, by arranging the optical axis of the light applied to the object 9 to be detected roughly perpendicular to the plane of the object 9 to be detected, fluctuations in the spot size can be reduced, and the detection accuracy of the object to be detected is improved.

Moreover, size reduction can be achieved by making coaxial the optical axis of the reflection light from the object 9 to be detected. Moreover, if the paths of the incident light and the reflection light are roughly perpendicular, then the reflected light incident on the light-receiving device comes to have a regular reflection component. Since the output level is larger than the diffused reflection component, the S/N ratio is increased to improve the detection accuracy, discrimination between the regular paper and the glossy paper, which have a small difference with regard to the surface state, can be easily achieved.

Moreover, by setting the diameter of the pinhole 15a to 10 μm to 50 μm, the reflection light from the limited region (at least a partial region in the light spot 18) on the object 9 to be detected can be received even though the size of the light spot 18 on the object 9 to be detected is varied to some extent, and the surface state can be prevented from being averaged, allowing the detection accuracy to be improved.

Moreover, the object 9 to be detected is retained by a guide 31 of the casing 30 so as to be located at a prescribed distance from the object lens 12, and fluctuations in the distance between the object 9 to be detected and the object lens 12 can be reduced, allowing accurate detection to be achieved.

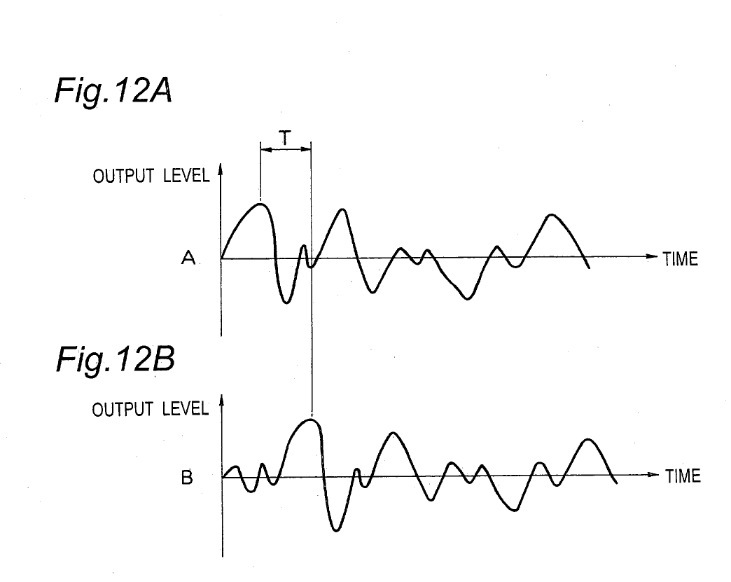

Moreover, when two sets of light-emitting devices 10, light-receiving devices 16 and optical systems (collimator lens 11, object lens 12, beam splitter 13 and light-receiving lens 14) are arranged at prescribed intervals in a straight line parallel to the direction of movement of the object 9 to be detected, then the output waveforms of the two light-receiving devices 16 in accordance with the movement of the object 9 to be detected become as shown in FIGS. 12A and 12B, where the other waveform B is delayed by a time T from one waveform A. Accordingly, by subjecting this delay to processing on an electric circuit, the travel speed of the object to be detected can be measured. Therefore, a small-size inexpensive optical object discriminating apparatus capable of detecting also the travel speed simultaneously with the detection of the type can be provided.

(Third Embodiment)

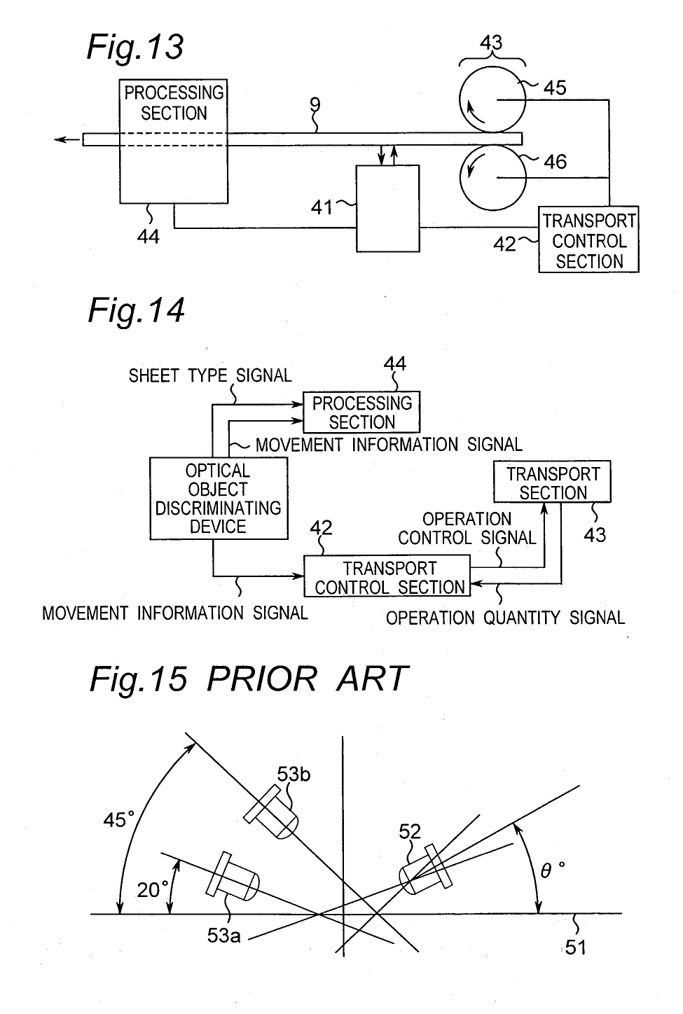

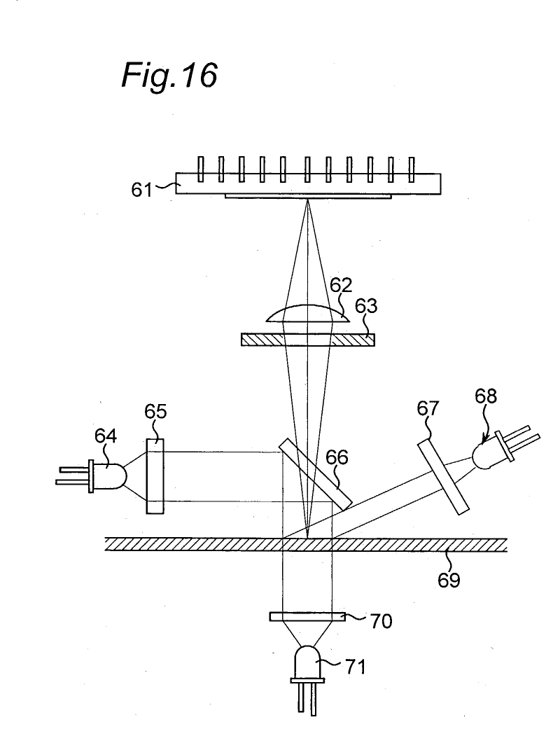

FIG. 13 is a schematic structural view of the transport processing system of the third embodiment of this invention, and FIG. 14 is a block diagram of the transport processing system.

In FIGS. 13 and 14, there are shown an optical object discriminating apparatus 41 for discriminating the type and detecting the travel speed of the object 9 to be detected such as sheet, a transport control section 42 for controlling the transportation of the object 9 to be detected upon receiving a movement information signal from the optical object discriminating apparatus 41, a transport section 43 that serves as a transport unit for transporting the object 9 to be detected by means of rollers 45 and 46 upon receiving a transport control signal from the transport control section 42, and a processing section 44 that serves as a processing unit for processing the object 9 to be detected upon receiving a sheet type signal from the optical object discriminating apparatus 41.

As shown in FIGS. 13 and 14, when the object 9 to be detected is subjected to some processing while being transported, it is possible to provide a transport processing system capable of carrying out the processing of the object 9 to be detected in a prescribed position through processing timing control by feeding the travel speed of the object 9 to be detected measured by the optical object discriminating apparatus 41 back to the processing section 44 while sending the sheet type information to the processing section 44.

In the third embodiment, there has been described the transport processing system for carrying out the prescribed processing by the processing section 44 while moving the object to be detected by the transport section 43. However, it is also possible to provide a transport system that maintains constant the speed of the object to be detected by feeding the travel speed of the object to be detected measured by the optical object discriminating apparatus back to the transport control section.

Moreover, it is acceptable to apply the optical object discriminating apparatus of this invention to a processing system that discriminates the sheet type and carries out processing in accordance with the sheet type.

Moreover, the optical object discriminating apparatus of this invention can be applied to the discrimination of the type of the recording medium as an object to be detected in a processing system or a transport processing system of a copying machine, a printer or the like, which carries out processing while transporting the recording medium of a paper such as a printing paper, a resin film, a sheet, or the like. It is to be noted that the object to be detected is not limited to the recording medium, and it is possible to discriminate the type of an object by means of the optical object discriminating apparatus of this invention so long as the object has a flat surface.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical object discriminating apparatus comprising:
a light-emitting device;
an optical system, which concentrates light emitted from the light-emitting device, forms a light spot having a prescribed spot diameter on an object to be detected by applying the light to the object to be detected moving in a prescribed direction and concentrates light reflected from at least a partial region in the light spot;
a light-receiving device on which the light concentrated via the optical system is incident; and
a discrimination section for discriminating a type of the object to be detected on the basis of amplitude and an output level of an output waveform of the light-receiving device.

2. The optical object discriminating apparatus as claimed in claim 1, wherein
the light-emitting device is a semiconductor laser device.

3. The optical object discriminating apparatus as claimed in claim 1, wherein
a pinhole is arranged in front of the light-receiving device.

4. The optical object discriminating apparatus as claimed in claim 1, wherein,
when light emitted from the light-emitting device is concentrated and applied to the object to be detected, an optical axis of the light is roughly perpendicular to a plane of the object to be detected.

5. The optical object discriminating apparatus as claimed in claim 1, wherein
an optical axis of light reflected and concentrated from a partial region in the light spot is coaxial with the optical axis on a light-applying side.

6. The optical object discriminating apparatus as claimed in claim 3, wherein
the pinhole has a diameter of 10 μm to 50 μm.

7. The optical object discriminating apparatus as claimed in claim 1, further comprising:
a casing having a guide for guiding the object to be detected.

8. A processing system employing the optical object discriminating apparatus claimed in claim 1, wherein,
when the object to be detected is processed by a processing unit while moving the object to be detected, processing in accordance with information of the type of the object to be detected is carried out by the processing unit on the basis of the information of the type of the object to be detected discriminated by the optical object discriminating apparatus.

9. The optical object discriminating apparatus as claimed in claim 1, further comprising:
two sets of the light-emitting devices, light-receiving devices and optical systems,
the two sets of the light-emitting devices, light-receiving devices and optical systems being arranged at prescribed intervals in a straight line parallel to the direction of movement of the object to be detected, and
a travel speed of the object to be detected being detected on the basis of output waveforms of the two light-receiving devices in accordance with the movement of the object to be detected.

10. A transport processing system, which has the optical object discriminating apparatus claimed in claim 9 and carries out prescribed processing by a processing unit while moving an object to be detected by a transport unit, wherein
processing in accordance with the type of the object to be detected is carried out in a prescribed position by the processing unit on the basis of information of the type and the travel speed of the object to be detected obtained by the optical object discriminating apparatus.
